(19) United States
(12) Patent Application Publication
(10) Pub. No.: US 2026/0046051 A1
(43) Pub. Date: Feb. 12, 2026

(54) CONDITIONAL INTERPRETATION OF CONTROL SIGNALING

(71) Applicant: QUALCOMM Incorporated, San Diego, CA (US)

(72) Inventors: Syed Hashim Ali SHAH, San Diego, CA (US); Alberto RICO ALVARINO, San Diego, CA (US)

(21) Appl. No.: 18/799,745

(22) Filed: Aug. 9, 2024

(51) Int. Cl. H04J 13/00; H04L 1/00; H04W 72/0453; H04W 72/231

(52) U.S. Cl. CPC H04J 13/004; H04L 1/0003; H04W 72/0453; H04W 72/231

(57) ABSTRACT

Methods, systems, and devices for wireless communications are described. A user equipment (UE) may receive first control signaling including a plurality of fields associated with uplink communications of the UE. The UE may determine an enablement status of orthogonal cover code (OCC) operations for the uplink communications based on whether values of the plurality of fields satisfy an OCC enablement condition that comprises satisfaction of at least two thresholds associated with at least two respective fields of the plurality of fields. The UE may communicate a message in accordance with the enablement status of OCC operations.

### FIELD OF TECHNOLOGY

The following relates to wireless communications, including conditional interpretation of control signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may receive control signaling from another device (e.g., a network node). However, approaches for communicating control information through control signaling may be improved.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling including a set of multiple fields associated with uplink communications of the UE, determining an enablement status of orthogonal cover code (OCC) operations for the uplink communications based on whether values of the set of multiple fields satisfy an OCC enablement condition that includes satisfaction of at least two thresholds associated with at least two respective fields of the set of multiple fields, and communicating a message in accordance with the enablement status of OCC operations.

A UE for wireless communications is described. The UE may include one or more memories storing processor executable code, and one or more processors coupled with the one or more memories. The one or more processors may individually or collectively be operable to execute the code to cause the UE to receive first control signaling including a set of multiple fields associated with uplink communications of the UE, determine an enablement status of orthogonal cover code (OCC) operations for the uplink communications based on whether values of the set of multiple fields satisfy an OCC enablement condition that includes satisfaction of at least two thresholds associated with at least two respective fields of the set of multiple fields, and communicate a message in accordance with the enablement status of OCC operations.

Another UE for wireless communications is described. The UE may include means for receiving first control signaling including a set of multiple fields associated with uplink communications of the UE, means for determining an enablement status of orthogonal cover code (OCC) operations for the uplink communications based on whether values of the set of multiple fields satisfy an OCC enablement condition that includes satisfaction of at least two thresholds associated with at least two respective fields of the set of multiple fields, and means for communicating a message in accordance with the enablement status of OCC operations.

A non-transitory computer-readable medium storing code for wireless communications is described. The code may include instructions executable by one or more processors to receive first control signaling including a set of multiple fields associated with uplink communications of the UE, determine an enablement status of orthogonal cover code (OCC) operations for the uplink communications based on whether values of the set of multiple fields satisfy an OCC enablement condition that includes satisfaction of at least two thresholds associated with at least two respective fields of the set of multiple fields, and communicate a message in accordance with the enablement status of OCC operations.

Some examples of the method, user equipment (UEs), and non-transitory computer-readable medium described herein may further include operations, features, means, or instructions for receiving second control signaling including one or more indications of the at least two thresholds, an indication of the OCC enablement condition, or both.

In some examples of the method, user equipment (UEs), and non-transitory computer-readable medium described herein, the OCC enablement condition may be a predefined condition, one or more of the at least two thresholds may be preset conditions, or both.

Some examples of the method, user equipment (UEs), and non-transitory computer-readable medium described herein may further include operations, features, means, or instructions for receiving second control signaling including one or more indications of the at least two respective fields.

In some examples of the method, user equipment (UEs), and non-transitory computer-readable medium described herein, the UE may be a narrowband internet of things (NB-IOT) device.

In some examples of the method, user equipment (UEs), and non-transitory computer-readable medium described herein, the at least two respective fields include a resource assignment field, a subcarrier indication field, a repetition number field, or a combination thereof.

Some examples of the method, user equipment (UEs), and non-transitory computer-readable medium described herein may further include operations, features, means, or instructions for determining, based on a value of a frequency domain resource allocation (FDRA) field included in the set of multiple fields, that a set of multiple bits of a modulation and coding scheme (MCS) field included in the set of multiple fields may be to be used for determination of an MCS to be used for communications involving the UE and determining the MCS based at least in part the set of multiple bits.

In some examples of the method, user equipment (UEs), and non-transitory computer-readable medium described herein, the determination that the set of multiple bits may be to be used for determination of the MCS may include operations, features, means, or instructions for determining that the value of the FDRA field satisfies a first MCS field interpretation condition of a set of multiple MCS field interpretation conditions, where each MCS field interpretation condition may be associated with a different quantity of the set of multiple bits that may be to be used for determination of the MCS.

Some examples of the method, user equipment (UEs), and non-transitory computer-readable medium described herein may further include operations, features, means, or instructions for receiving third control signaling including one or more indications of one or more FDRA value thresholds associated with the set of multiple MCS field interpretation conditions.

In some examples of the method, user equipment (UEs), and non-transitory computer-readable medium described herein, the set of multiple fields includes a time domain resource allocation field, a frequency domain resource allocation field, a modulation and coding scheme field, an uplink shared channel indicator field, or a combination thereof.

In some examples of the method, user equipment (UEs), and non-transitory computer-readable medium described herein, the first control signaling may be downlink control information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports conditional interpretation of control signaling in accordance with one or more examples as disclosed herein.

FIG. 2 shows an example of a wireless communications system that supports conditional interpretation of control signaling in accordance with one or more examples as disclosed herein.

FIG. 3 shows an example of an interpretation scheme that supports conditional interpretation of control signaling in accordance with one or more examples as disclosed herein.

FIG. 4 shows an example of an interpretation scheme that supports conditional interpretation of control signaling in accordance with one or more examples as disclosed herein.

FIG. 5 shows an example of an interpretation scheme that supports conditional interpretation of control signaling in accordance with one or more examples as disclosed herein.

FIG. 6 shows an example of an interpretation scheme that supports conditional interpretation of control signaling in accordance with one or more examples as disclosed herein.

FIG. 7 shows an example of a process flow that supports conditional interpretation of control signaling in accordance with one or more examples as disclosed herein.

FIGS. 8 and 9 show block diagrams of devices that support conditional interpretation of control signaling in accordance with one or more examples as disclosed herein.

FIG. 10 shows a block diagram of a communications manager that supports conditional interpretation of control signaling in accordance with one or more examples as disclosed herein.

FIG. 11 shows a diagram of a system including a device that supports conditional interpretation of control signaling in accordance with one or more examples as disclosed herein.

FIG. 12 shows a flowchart illustrating methods that support conditional interpretation of control signaling in accordance with one or more examples as disclosed herein.

### DETAILED DESCRIPTION

In wireless communications, control signaling such as downlink control information (DCI) may be employed to communicate configuration information. As wireless communications continue advancing, greater demands may be placed on DCI transmissions to carry greater amounts of information, which may increase the size of DCI transmissions. As such, it may be desirable to more fully utilize quantities of bits that are used for DCI transmissions.

Techniques for conditional interpretation of DCI transmissions may be employed. For example, DCI may be interpreted in a first manner if one or more conditions are met and the DCI may be interpreted in a second manner if the one or more conditions are not met. Further, satisfaction of one or more first conditions may be associated with a first interpretation, satisfaction of one or more second conditions may be associated with a second interpretation, and so forth for any quantity of conditions and associated interpretations. For example, an (orthogonal cover code) OCC flag may be enabled or disabled based on values of one or more fields in a DCI transmission. Additionally, or alternatively, the OCC flag may be enabled or disables for narrowband internet of things (NB-IOT) operations based on values of one or more fields. Additionally, or alternatively, one or more modulation and coding scheme (MCS) fields may be interpreted differently based on a frequency domain resource allocation (FDRA). In at least these ways, communications quality, throughput, resource utilization, flexibility, and reliability may be increased while reducing overhead and latency. For example, such approaches may facilitate the use of OCC, which may contribute to such benefits, along with the direct benefits of conditional interpretation of DCI transmissions.

Aspects of the disclosure are initially described in the context of wireless communications systems. Aspects of the disclosure are then described with reference to a wireless communications system, interpretation schemes, and a process flow. Aspects of the disclosure are further illustrated by and described with reference to apparatus diagrams, system diagrams, and flowcharts that relate to conditional interpretation of control signaling.

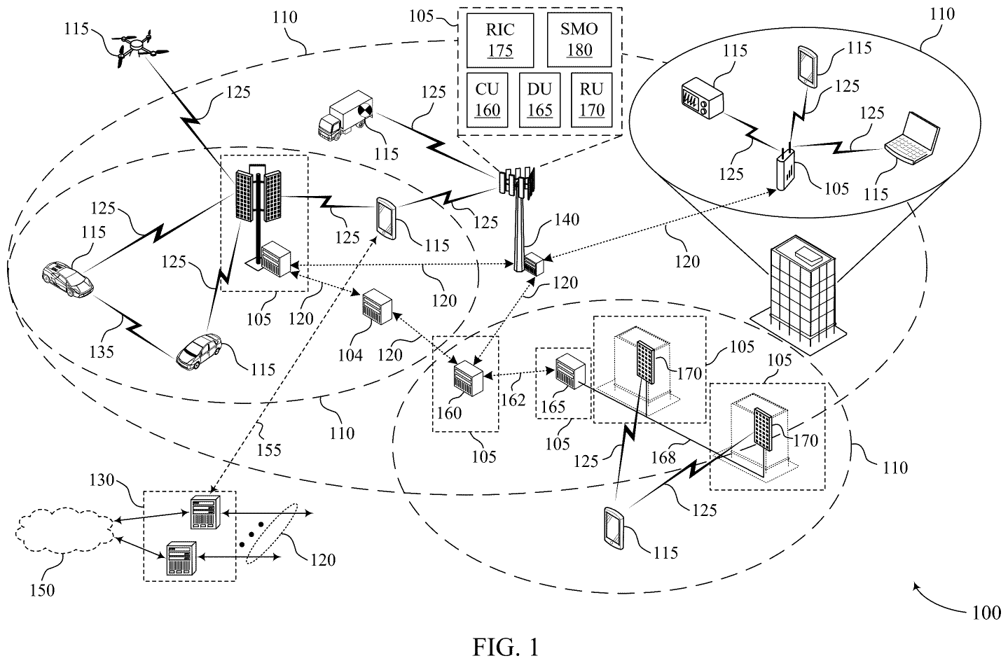

FIG. 1 shows an example of a wireless communications system 100 that supports conditional interpretation of control signaling in accordance with one or more examples as disclosed herein. The wireless communications system 100 may include one or more devices, such as one or more network devices (e.g., network nodes 105, which may also be known as network entities), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network node, or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be a UE 115. In another aspect of this example, the first node may be a UE 115, the second node may be a network node 105, and the third node may be a network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network nodes (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network nodes (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network nodes, such as one or more of the network nodes 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network node 105 may provide communication coverage via one or more cells, for example a macro cell, a small cell, a hot spot, or other types of cells, or any combination thereof. The term “cell” may refer to a logical communication entity used for communication with a network node 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network node 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network node 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network node 105 may support one or more cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (cMBB)) that may provide access for different types of devices.

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network nodes (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may support synchronous or asynchronous operation. For synchronous operation, network nodes 105 (e.g., base stations 140) may have similar frame timings, and transmissions from different network nodes (e.g., different ones of the network nodes 105) may be approximately aligned in time. For asynchronous operation, network nodes 105 may have different frame timings, and transmissions from different network nodes (e.g., different ones of network nodes 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network node 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network nodes 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network nodes 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by a transmitting device (e.g., a network node 105 or a UE 115) along a single beam direction (e.g., a direction associated with the receiving device, such as another network node 105 or UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a UE may receive control signaling that may indicate one or more parameters in one or more fields. The UE may determine whether one or more values in the one or more fields satisfy one or more thresholds associated with one or more conditions for enabling or performing operations, such as enabling the use of OCC operations at the UE. For example, a condition for enabling OCC operations may include satisfaction of one or more thresholds of values of fields that are associated with OCC operations or that support OCC operations. If the thresholds are satisfied and, accordingly, the condition is met, then the UE may enable or perform one or more operations (e.g., enabling or performing OCC operations).

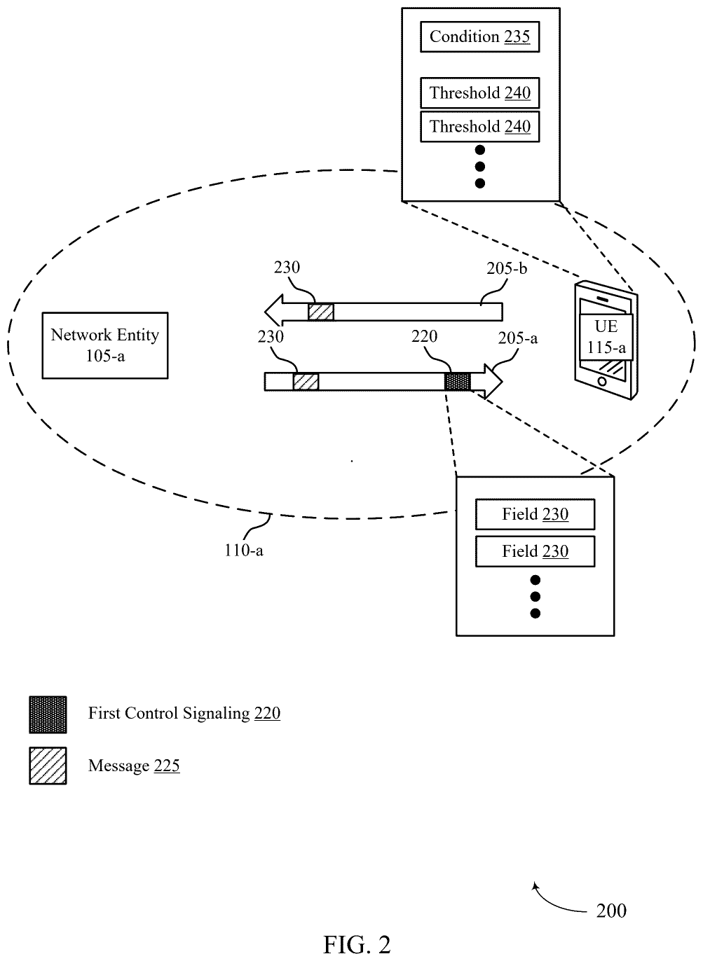

FIG. 2 shows an example of a wireless communications system 200 that supports conditional interpretation of control signaling in accordance with one or more examples as disclosed herein. The wireless communications system 200 may include the network node 105-a, which may be an example of one or more network nodes discussed in relation to other figures. The wireless communications system 200 may include the UE 115-a, which may be an example of UEs discussed in relation to other figures.

In some examples, the UE 115-a may be located in a geographic coverage area 110-a that may be associated with the network node 105-a. The network node 105-a and UE 115-a may communicate via one or more downlink communication links 205-a and one or more uplink communication links 205-b.

In some wireless communications systems, physical layer control communications may include DCI. DCI may include information that schedules downlink data channel (e.g., physical downlink shared channel (PDSCH)) usage, uplink data channel (e.g., physical uplink shared channel (PUSCH)) usage, or other operations. In some examples, DCI may inform (e.g., in a dynamic manner) a UE what uplink or downlink resources in time and frequency are allocated to the UE for transmission or reception. Additionally, or alternatively, DCI may include information about transmission or reception characteristics such as power control, MCS information, frequency hopping, antenna port mapping, one or more other characteristics or information, or any combination thereof. In some examples, different DCI formats that serve different purposes for different scenarios may be employed. In some examples, a bit in a DCI transmission may be considered a precious commodity. In some examples, DCI may be carried over a physical downlink control channel (PDCCH).

In some examples, a DCI transmission may include various fields, parameters, or indications, including, but not limited to, one or more of (including multiples of) a DCI format identifier, a carrier indicator, an uplink/supplementary uplink indicator, a bandwidth part indicator, a frequency domain resource assignment (FDRA) parameter, a time domain resource assignment (TDRA) parameter, a frequency hopping flag, an MCS parameter, a new data indicator, a redundancy version, a HARQ process number, a 1st downlink assignment index, a 2nd downlink assignment index, a transmit power control command (e.g., for a scheduled transmission, such as a PUSCH transmission), a sounding reference signal resource indicator, precoding information (e.g., a quantity of layers), a quantity of antenna ports, a sounding reference signal request, a channel state information request, code block group transmission information (CBGTI), a phase tracking reference signal (PTRS) demodulation reference signal (DMRS) association, a beta_offset indicator, a DMRS sequence initialization, an uplink shared channel (UL-SCH) indicator, or any combination thereof.

In some examples, a DCI transmission for an IoT device, such as an NB-IOT device, may include various fields, parameters, or indications, including, but not limited to, one or more of (including multiples of) a flag for N0/N1 format differentiation, a subcarrier indication, a resource assignment, a scheduling delay, an MCS parameter, a redundancy version, a repetition number, a new data indicator, a DCI subframe repetition number, or any combination thereof.

As wireless communications continues advancing, increasing amounts of information may be carried to the UE via DCI, possibly increasing the DCI size. This increase in DCI size may impact control channel performance negatively.

For example, the use of OCC may impact DCI operations. OCC is designed to increase PUSCH capacity. In some approaches, for UEs to use OCC correctly, there may be addition of one or more bits to DCI transmissions. However, such additions may worsen DCI decoding performance. In some other approaches, a new DCI format may be introduced. However, use of such a new format involves a substantial increase in decoding (e.g., blind decoding) complexity.

Therefore, it may be desirable to better utilize the information bits that are available in existing DCI formats (e.g., to indicate techniques like OCC or other techniques). For example, as described herein, different interpretations of DCI may be made based on one or more conditions or thresholds being satisfied by one or more values of one or more fields in the DCI. For example, if condition A is true for a given set of fields, then DCI is read in a first manner, if condition B is true for the given set of fields, then DCI is read in a second manner, and so on. Such approaches may be employed in connection with OCC operations or other operations.

For example, the UE 115-a may receive the first control signaling 220 that includes or indicates one or more fields 230 that may be associated with uplink communications or other communications of the UE 115-a. The UE 115-a may determine an enablement status of OCC operations (or other operations) for the uplink communications (or other communications) based on whether one or more values of the fields 230 satisfy a condition 235 (e.g., an OCC enablement condition) that may be based on or may be dependent on satisfaction of one or more thresholds 240 associated with one or more of the fields 230. If the thresholds 240 are satisfied, the condition 235 may be satisfied, and the UE 115-a may communicate a message 225 in accordance with the enablement status of OCC operations (or other operations).

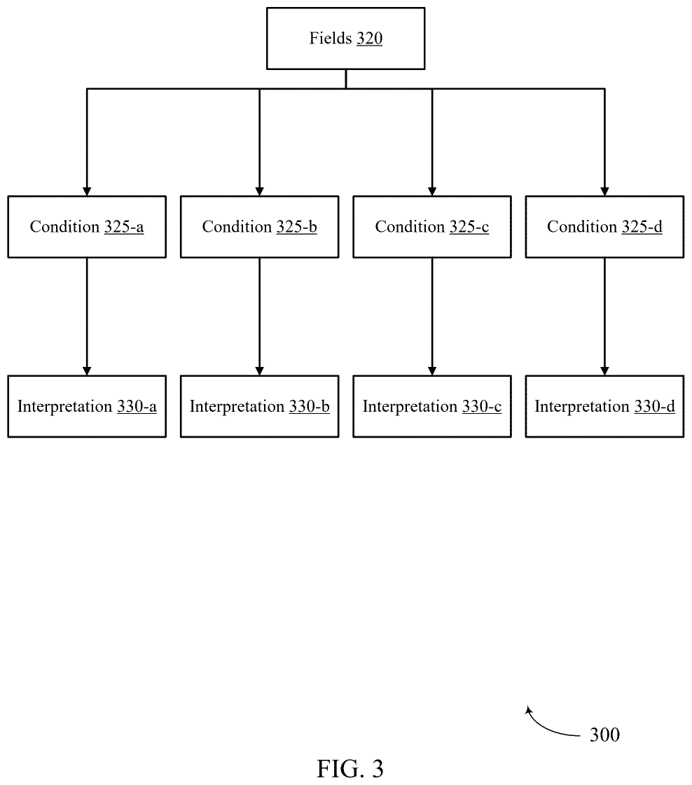

FIG. 3 shows an example of an interpretation scheme 300 that supports conditional interpretation of control signaling in accordance with one or more examples as disclosed herein. The interpretation scheme 300 may include or involve one or more fields 320, one or more conditions 235, and one or more interpretations 330. Though the condition 325-a, the condition 325-b, the condition 325-c, and the condition 325-d are described, some or all of these may belong to a same condition and the condition 325-a, the condition 325-b, the condition 325-c, and the condition 325-d may describe or symbolize different outcomes (e.g., satisfaction or unsatisfaction) of the condition. Additionally, or alternatively, the condition 325-a, the condition 325-b, the condition 325-c, and the condition 325-d may be different conditions that may be satisfied (or fail to be satisfied) independently or in groups.

The interpretation scheme 300 may include the interpretation 330-a, the interpretation 330-b, the interpretation 330-c, and the interpretation 330-d. In some examples, each of these may be associated with a corresponding condition (e.g., the condition 325-a, the condition 325-b, the condition 325-c, and the condition 325-d). In some examples, each interpretation may be made based on satisfaction or dissatisfaction of the associated condition. For example, if condition 325-a is satisfied (or unsatisfied), then interpretation 330-a may be made and one or more actions or operations may be performed as a result of the interpretation. Similar scenarios may be considered that involve the condition 325-b and the interpretation 330-b, the condition 325-c and the interpretation 330-c, and the condition 325-d and the interpretation 330-d.

In some examples, for a given DCI format, the UE may read the values of a set of fields 320 (e.g., one or more fields) from the DCI (e.g., fields a, b, c, and d). If one or more of the fields 320 satisfy a condition (e.g., field a is enabled, b is disabled, field c is greater than x and field d is less than y), then the UE may interpret the DCI in different manners. Such techniques (and any of the techniques described herein) may be applied to any one or more fields 320 of DCI or other control signaling, any one or more conditions 325, any one or more interpretations 330, or any combination thereof.

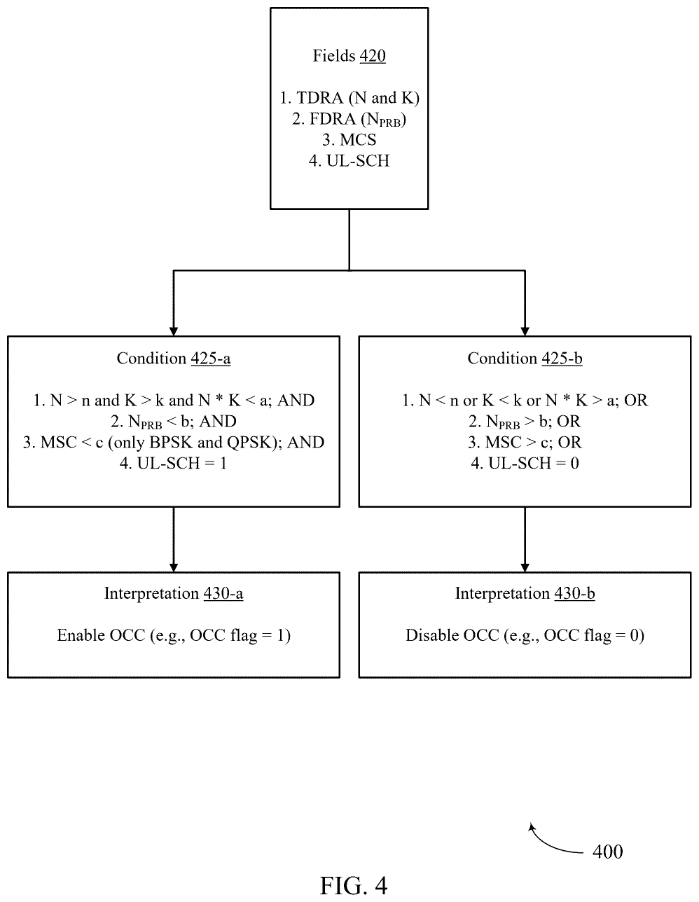

FIG. 4 shows an example of an interpretation scheme 400 that supports conditional interpretation of control signaling in accordance with one or more examples as disclosed herein. The interpretation scheme 400 may involve the fields 420, the condition 425-a, the condition 425-b, the interpretation 430-a, and the interpretation 430-b. Here, condition 425-a may represent satisfaction of an example, condition, and condition 425-b may represent dissatisfaction or unsatisfaction of the same example condition.

As described herein, OCC may be employed to increase uplink capacity for wireless communications, including NR operations and NB-IOT operations. However, in some approaches, DCI transmissions may not include a field for enabling or disabling OCC (e.g., there may be no OCC flag). The techniques described herein may allow for enabling or disabling OCC without adding additional fields to DCI.

For example, a UE may interpret the DCI to either enable or disable OCC (e.g., as shown by interpretation 430-a and interpretation 430-b, respectively) based on one or more fields 420 of a DCI.

In some examples, the fields 420 may include one or more fields. For example, the fields may include a TDRA field. This field in DCI may inform the UE about time resources allocated to UE (e.g., a quantity of repetitions K and a quantity of slots N to be used for transport block processing over multiple slots (TBoMS)). For OCC operations, it may be desirable to have a considerable quantity of TBoMS slots and repetitions. This may be considered in the determination as to whether the condition 425 is satisfied (e.g., as shown in the condition 425-a) or not (e.g., as shown in the condition 425-b).

Additionally, or alternatively, the fields 420 may include an FDRA field. From a DCI, the UE may read the FDRA field to calculate the quantity of frequency resources (e.g., physical resource blocks (PRBs) represented as NPRB) allocated, which translates or corresponds to a bandwidth for communications. The advantages of OCC may be observed in low bandwidth regime. As such, it may be desirable for an NPRB value derived from the FDRA field to be small for utilization of OCC. This may be considered in the determination as to whether the condition 425 is satisfied (e.g., as shown in the condition 425-a) or not (e.g., as shown in the condition 425-b).

Additionally, or alternatively, the fields 420 may include an MCS field. For OCC to work well, it may be desirable to have an MCS with low modulation orders and low coding rates (e.g., low coding rate MCSs with quadrature phase shift keying (QPSK), which may be a modulation order of 2, or binary phase shift keying (BPSK), which may be a modulation order of 1). This may be considered in the determination as to whether the condition 425 is satisfied (e.g., as shown in the condition 425-a) or not (e.g., as shown in the condition 425-b).

Additionally, or alternatively, the fields 420 may include an UL-SCH indicator field. Such a field may indicate whether a PUSCH transmission is to carry data or not. If it is desirable for an OCC operation to involve carrying uplink data, it may be desirable to have this field be set in order to enable OCC. This may be considered in the determination as to whether the condition 425 is satisfied (e.g., as shown in the condition 425-a) or not (e.g., as shown in the condition 425-b).

As depicted, satisfaction of the condition 425 (e.g., as demonstrated with reference to the condition 425-a) involves satisfaction of the various thresholds or sub-conditions described in relation to each of the fields 420. Further, satisfaction of the condition 425 (e.g., with reference to the condition 425-a) may involve satisfaction of multiple such thresholds or sub-conditions, resulting in the interpretation 430-a being made, which involves enablement of OCC operations. In contrast, the dissatisfaction of the condition 425 (e.g., with reference to the condition 425-b) may involve dissatisfaction of any one or more of the various thresholds or sub-conditions described in relation to each of the fields 420, resulting in the interpretation 430-b being made, which involves disablement (or simply not enabling) of OCC operations.

In some examples, the various thresholds or sub-conditions may be represented by n, k, a, b, and c. In some examples, n, k, a, b, and c may be set in an RRC configuration (e.g., and received by the UE) along with the relevant conditions. Additionally, or alternatively, the values of n, k, a, b, and c may be set (e.g., in a table or otherwise) in a wireless communications specification or standard along with the relevant conditions (or otherwise predefined). Additionally, or alternatively, the values of n, k, a, b, and c may be set in an RRC configuration but the relevant conditions may be set (e.g., in a table or otherwise) in a wireless communications specification or standard.

In some examples, the conditions described herein may not be fixed. For example, such conditions (e.g., the condition 425-a and the condition 425-b) may be changed or swapped out for another condition based on one or more factors for flexibility. For example, one or more thresholds or sub-conditions may be included or excluded for different communications scenarios (e.g., based on one or more factors, including channel characteristics, one or more device capabilities, one or more device classifications or types, one or more measurements, one or more other factors, or any combination thereof). Further, in some examples, some conditions may not include a full set of relevant fields, but may include a sub-set (e.g., one or more) of relevant fields.

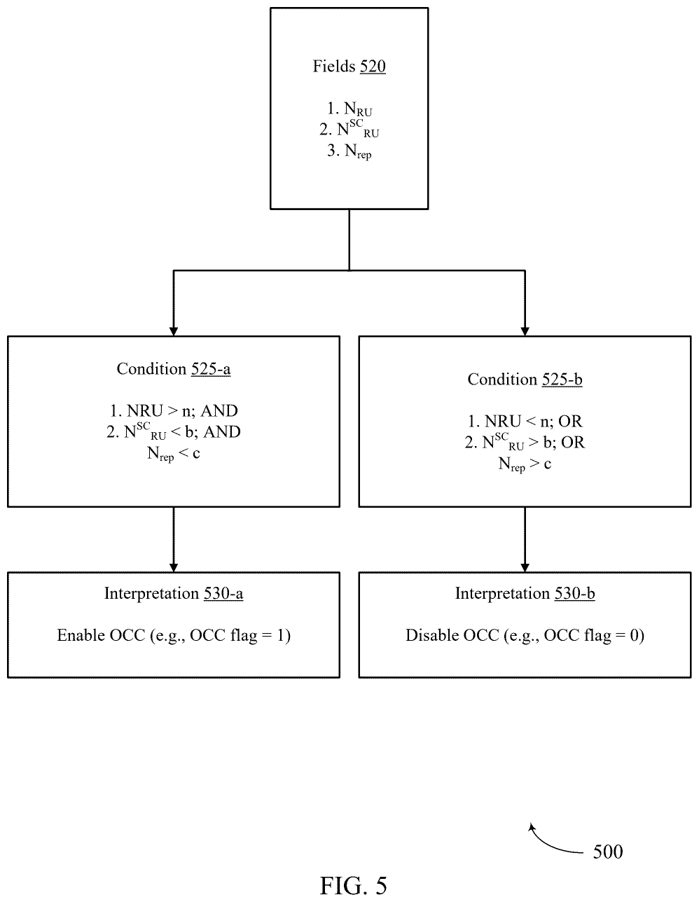

FIG. 5 shows an example of an interpretation scheme 500 that supports conditional interpretation of control signaling in accordance with one or more examples as disclosed herein.

OCC techniques may also be employed in situations involving NB-IOT devices. However, in some approaches, DCIs for NB-IOT may not include any field for enabling or disabling OCC (e.g., there may be no OCC flag included in NB-IOT DCI transmissions). By using conditional interpretation, the DCI may be employed to indicate enablement or disablement of OCC based on values of various fields 520.

In some examples, the fields 520 may include one or more fields. For example, the fields 520 may include a resource assignment field. This field in DCI indicates time resources allocated to UE (e.g., a quantity of resource units (RUS), NRU) for communications. For OCC operations, it may be desirable to have a considerable quantity of RUs. This may be considered in the determination as to whether the condition 525 is satisfied (e.g., as shown in the condition 525-a) or not (e.g., as shown in the condition 525-b).

In some examples, the fields 520 may include a subcarrier indication field (e.g., which may be analogous to the FDRA field described herein, but for NB-IOT devices). In some examples, the advantages of OCC may be observed in a low bandwidth regime. The subcarrier indication may indicate to the NB-IOT UE how many sub-carriers

$${N}_{RU}^{SC} ,$$

to use for communications. Thus, to support OCC operations, a

$${N}_{RU}^{SC}$$

derived from such a subcarrier indication should be small. This may be considered in the determination as to whether the condition 525 is satisfied (e.g., as shown in the condition 525-a) or not (e.g., as shown in the condition 525-b).

In some examples, the fields 520 may include a repetition number field. In some examples, it may be desirable to have a considerable number of repetitions Nrep for OCC operations. This may be considered in the determination as to whether the condition 525 is satisfied (e.g., as shown in the condition 525-a) or not (e.g., as shown in the condition 525-b).

In some examples, the use of the resource assignment field and the repetition number field together may be analogous or similar to the TDRA field described herein.

As depicted, satisfaction of the condition 525 (e.g., as demonstrated with reference to the condition 525-a) involves satisfaction of the various thresholds or sub-conditions described in relation to each of the fields 520. Further, satisfaction of the condition 525 (e.g., with reference to the condition 525-a) may involve satisfaction of multiple such thresholds or sub-conditions, resulting in the interpretation 530-a being made, which involves enablement of OCC operations. In contrast, the dissatisfaction of the condition 525 (e.g., with reference to the condition 525-b) may involve dissatisfaction of any one or more of the various thresholds or sub-conditions described in relation to each of the fields 520, resulting in the interpretation 530-b being made, which involves disablement (or simply not enabling) of OCC operations.

In some examples, the various thresholds or sub-conditions may be represented by n, b, and c. In some examples, n, b, and c may be set in an RRC configuration (e.g., and received by the UE) along with the relevant conditions. Additionally, or alternatively, the values of n, b, and c may be set (e.g., in a table or otherwise) in a wireless communications specification or standard along with the relevant conditions (or otherwise predefined). Additionally, or alternatively, the values of n, b, and c may be set in an RRC configuration but the relevant conditions may be set (e.g., in a table or otherwise) in a wireless communications specification or standard.

In some examples, the conditions described herein may not be fixed. For example, such conditions (e.g., the condition 525-a and the condition 525-b) may be changed or swapped out for another condition based on one or more factors for flexibility. For example, one or more thresholds or sub-conditions may be included or excluded for different communications scenarios (e.g., based on one or more factors, including channel characteristics, one or more device capabilities, one or more device classifications or types, one or more measurements, one or more other factors, or any combination thereof). Further, in some examples, some conditions may not include a full set of relevant fields, but may include a sub-set (e.g., one or more) of relevant fields.

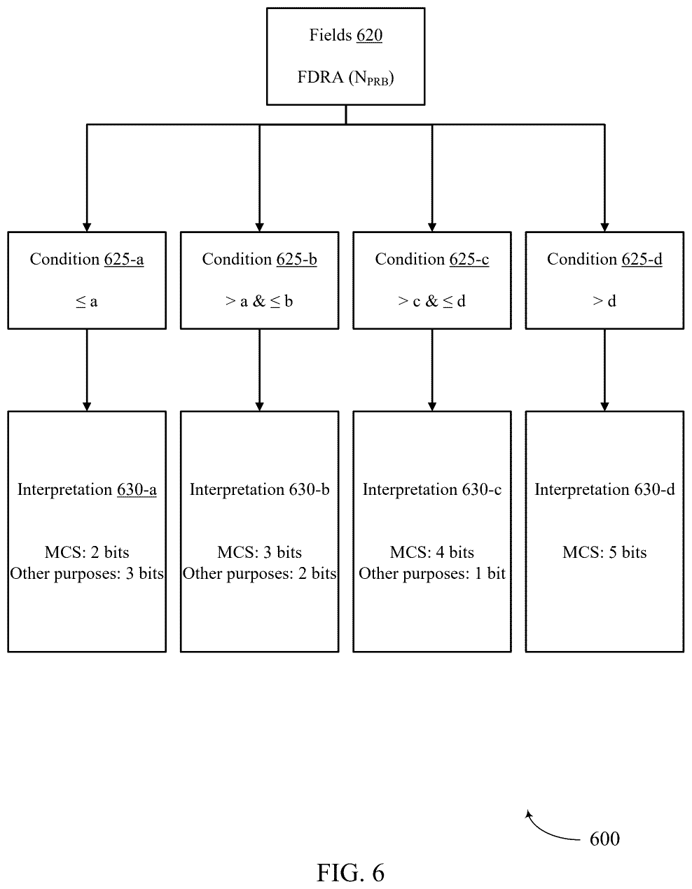

FIG. 6 shows an example of an interpretation scheme 600 that supports conditional interpretation of control signaling in accordance with one or more examples as disclosed herein.

In some examples, an MCS field may be interpreted different based on one or more values of an FDRA field. For example, in some approaches to wireless communications, 5 bits in a DCI may be reserved for MCS to address a total of 32 entries in MCS table. In some examples, the entries may be ordered in an ascending manner over coding rate. For bandwidth scarce and limited coverage scenarios with low SNRs (e.g., non-terrestrial networks (NTN)) it may not be desirable to operate in high coding rate regimes (e.g., corresponding to higher MCS indices).

Based on the FDRA field, a UE may interpret the 5 bits dedicated to MCS differently based on NPRB associated with the FDRA field. For example, if NPRB is small, the UE may employ smaller MCS values (e.g., up to MCS 7, as an example). As a result, the UE may employ 3 bits to calculate the MCS index and the UE may use the remaining two bits for another purpose.

For example, as depicted in FIG. 6, the fields 620 may include the FDRA field that indicates the NPRB value. The condition 625-a, the condition 625-b, the condition 625-c, and the condition 625-d may be associated with respective possible ranges of the NPRB value, such that if the NPRB value falls within the range corresponding to a condition, that condition may be satisfied, and the corresponding interpretation (e.g., the interpretation 630-a corresponding to the condition 625-a, the interpretation 630-b corresponding to the condition 625-b, the interpretation 630-c corresponding to the condition 625-c, or the interpretation 630-d corresponding to the condition 625-d) may be made.

As depicted in FIG. 6, one or more threshold values a, b, c, and d may be used to define the respective possible ranges of the NPRB value. In some examples, the various thresholds or sub-conditions may be represented by a, b, c, and d. In some examples, a, b, c, and d may be set in an RRC configuration (e.g., and received by the UE) along with the relevant conditions. Additionally, or alternatively, the values of a, b, c, and d may be set (e.g., in a table or otherwise) in a wireless communications specification or standard along with the relevant conditions (or otherwise predefined). Additionally, or alternatively, the values of a, b, c, and d may be set in an RRC configuration but the relevant conditions may be set (e.g., in a table or otherwise) in a wireless communications specification or standard.

In some examples, the conditions described herein may not be fixed. For example, such conditions (e.g., the condition 625-a, the condition 625-b, the condition 625-c, and the condition 625-d) may be changed or swapped out for another condition based on one or more factors for flexibility. For example, one or more thresholds or sub-conditions may be included or excluded for different communications scenarios (e.g., based on one or more factors, including channel characteristics, one or more device capabilities, one or more device classifications or types, one or more measurements, one or more other factors, or any combination thereof). Further, in some examples, some conditions may not include a full set of relevant fields, but may include a sub-set (e.g., one or more) of relevant fields.

In some examples, the unused bits of the MCS that are designated for use for other purposes (e.g., in situations in which the condition 625-a, the condition 625-b, or the condition 625-c are satisfied), the unused bits may be assigned to signal or indicate any other information, including the enablement or disablement of OCC or one or more other operations or information.

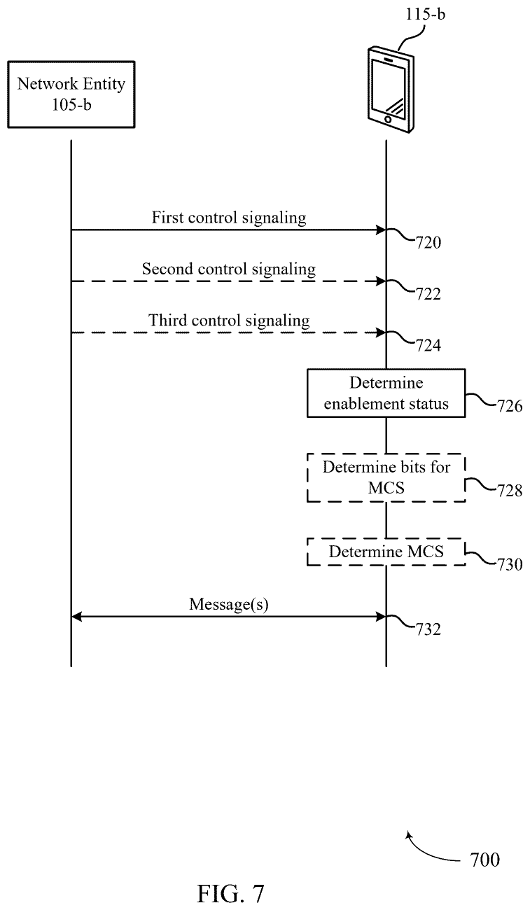

FIG. 7 shows an example of a process flow 700 that supports conditional interpretation of control signaling in accordance with one or more examples as disclosed herein.

The process flow 700 may implement various aspects of the present disclosure described herein. The elements described in the process flow 700 (e.g., UE 115-b and network node 105-b) may be examples of similarly named elements described herein.

In the following description of the process flow 700, the operations between the various entities or elements may be performed in different orders or at different times. Some operations may also be left out of the process flow 700, or other operations may be added. Although the various entities or elements are shown performing the operations of the process flow 700, some aspects of some operations may also be performed by other entities or elements of the process flow 700 or by entities or elements that are not depicted in the process flow, or any combination thereof.

At 720, the UE 115-b may receive first control signaling that may include a plurality of fields associated with uplink communications of the UE. In some examples, the UE may be a narrowband internet of things (NB-IOT) device. In some examples, the plurality of fields may include a time domain resource allocation field, a frequency domain resource allocation field, a modulation and coding scheme field, an uplink shared channel indicator field, or a combination thereof. In some examples, the first control signaling is downlink control information

At 722, the UE 115-b may receive second control signaling that may include one or more indications of the at least two thresholds, an indication of the OCC enablement condition, or both. Additionally, or alternatively, the UE 115-b may receive second control signaling that may include one or more indications of the at least two respective fields.

At 724, the UE 115-b may receive third control signaling that may include one or more indications of one or more FDRA value thresholds associated with the plurality of MCS field interpretation conditions.

At 726, the UE 115-b may determine an enablement status of orthogonal cover code (OCC) operations for the uplink communications based on whether values of the plurality of fields satisfy an OCC enablement condition that may include satisfaction of at least two thresholds associated with at least two respective fields of the plurality of fields. In some examples, the OCC enablement condition is a predefined condition, one or more of the at least two thresholds are preset conditions, or both. In some examples, the at least two respective fields comprise a resource assignment field, a subcarrier indication field, a repetition number field, or a combination thereof.

At 728, the UE 115-b may determine, based on a value of a frequency domain resource allocation (FDRA) field included in the plurality of fields, that a plurality of bits of a modulation and coding scheme (MCS) field included in the plurality of fields are to be used for determination of an MCS to be used for communications involving the UE. In some examples, to determine that the plurality of bits are to be used for determination of the MCS, the UE 115-b may determine that the value of the FDRA field satisfies a first MCS field interpretation condition of a plurality of MCS field interpretation conditions and each MCS field interpretation condition is associated with a different quantity of the plurality of bits that are to be used for determination of the MCS.

At 730, the UE 115-b may determine the MCS based at least in part the plurality of bits.

At 732, the UE 115-b may communicate a message in accordance with the enablement status of OCC operations.

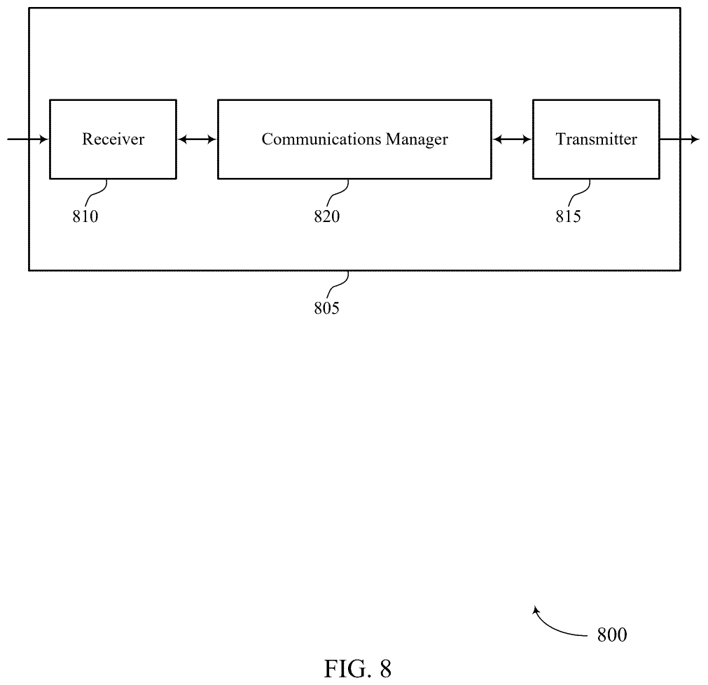

FIG. 8 shows a block diagram 800 of a device 805 that supports conditional interpretation of control signaling in accordance with one or more examples as disclosed herein. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to conditional interpretation of control signaling). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to conditional interpretation of control signaling). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of conditional interpretation of control signaling as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

Additionally, or alternatively, the communications manager 820 may support wireless communications in accordance with examples as disclosed herein. For example, the communications manager 820 is capable of, configured to, or operable to support a means for receiving first control signaling including a set of multiple fields associated with uplink communications of the UE. The communications manager 820 is capable of, configured to, or operable to support a means for determining an enablement status of orthogonal cover code (OCC) operations for the uplink communications based on whether values of the set of multiple fields satisfy an OCC enablement condition that includes satisfaction of at least two thresholds associated with at least two respective fields of the set of multiple fields. The communications manager 820 is capable of, configured to, or operable to support a means for communicating a message in accordance with the enablement status of OCC operations.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources, or any combination thereof.

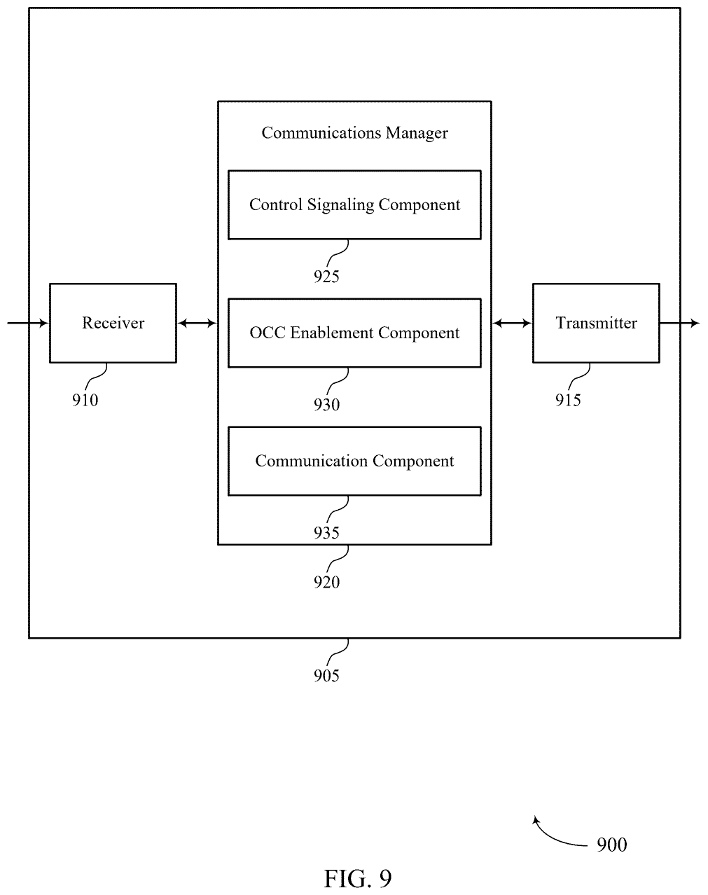

FIG. 9 shows a block diagram 900 of a device 905 that supports conditional interpretation of control signaling in accordance with one or more examples as disclosed herein. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to conditional interpretation of control signaling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to conditional interpretation of control signaling). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of conditional interpretation of control signaling as described herein. For example, the communications manager 920 may include a control signaling component 925, a OCC enablement component 930, a communication component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The control signaling component 925 is capable of, configured to, or operable to support a means for receiving first control signaling including a set of multiple fields associated with uplink communications of the UE. The OCC enablement component 930 is capable of, configured to, or operable to support a means for determining an enablement status of orthogonal cover code (OCC) operations for the uplink communications based on whether values of the set of multiple fields satisfy an OCC enablement condition that includes satisfaction of at least two thresholds associated with at least two respective fields of the set of multiple fields. The communication component 935 is capable of, configured to, or operable to support a means for communicating a message in accordance with the enablement status of OCC operations.

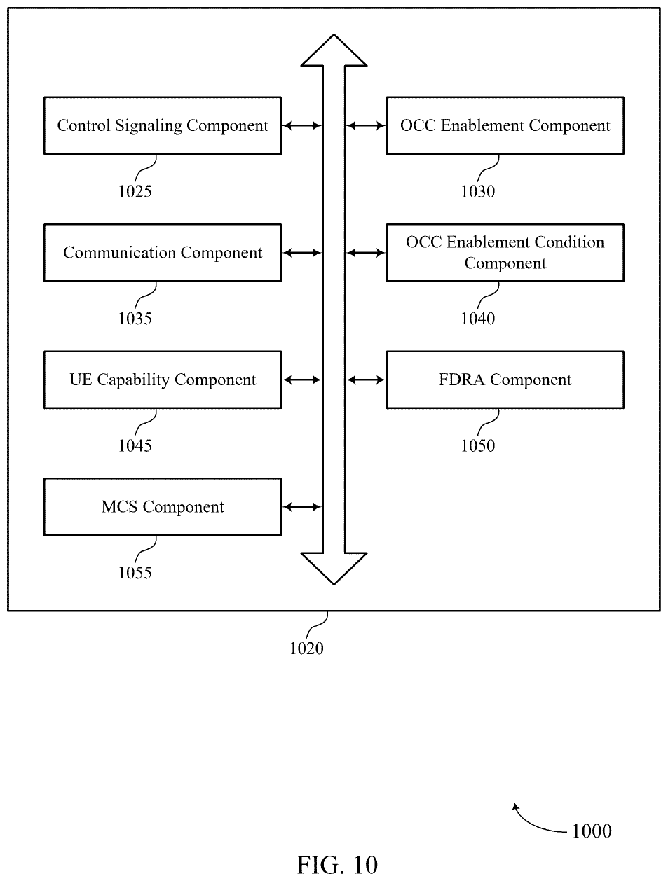

FIG. 10 shows a block diagram 1000 of a communications manager 1020 that supports conditional interpretation of control signaling in accordance with one or more examples as disclosed herein. The communications manager 1020 may be an example of aspects of a communications manager 820, a communications manager 920, or both, as described herein. The communications manager 1020, or various components thereof, may be an example of means for performing various aspects of conditional interpretation of control signaling as described herein. For example, the communications manager 1020 may include a control signaling component 1025, a OCC enablement component 1030, a communication component 1035, a OCC enablement condition component 1040, a UE capability component 1045, an FDRA component 1050, an MCS component 1055, or any combination thereof. Each of these components, or components or subcomponents thereof (e.g., one or more processors, one or more memories), may communicate, directly or indirectly, with one another (e.g., via one or more buses).

Additionally, or alternatively, the communications manager 1020 may support wireless communications in accordance with examples as disclosed herein. The control signaling component 1025 is capable of, configured to, or operable to support a means for receiving first control signaling including a set of multiple fields associated with uplink communications of the UE. The OCC enablement component 1030 is capable of, configured to, or operable to support a means for determining an enablement status of orthogonal cover code (OCC) operations for the uplink communications based on whether values of the set of multiple fields satisfy an OCC enablement condition that includes satisfaction of at least two thresholds associated with at least two respective fields of the set of multiple fields. The communication component 1035 is capable of, configured to, or operable to support a means for communicating a message in accordance with the enablement status of OCC operations.

In some examples, the OCC enablement condition component 1040 is capable of, configured to, or operable to support a means for receiving second control signaling including one or more indications of the at least two thresholds, an indication of the OCC enablement condition, or both.

In some examples, the OCC enablement condition is a predefined condition, one or more of the at least two thresholds are preset conditions, or both.

In some examples, the control signaling component 1025 is capable of, configured to, or operable to support a means for receiving second control signaling including one or more indications of the at least two respective fields.

In some examples, the UE is a narrowband internet of things (NB-IOT) device.

In some examples, the at least two respective fields include a resource assignment field, a subcarrier indication field, a repetition number field, or a combination thereof.

In some examples, the FDRA component 1050 is capable of, configured to, or operable to support a means for determining, based on a value of a frequency domain resource allocation (FDRA) field included in the set of multiple fields, that a set of multiple bits of a modulation and coding scheme (MCS) field included in the set of multiple fields are to be used for determination of an MCS to be used for communications involving the UE. In some examples, the MCS component 1055 is capable of, configured to, or operable to support a means for determining the MCS based at least in part the set of multiple bits.

In some examples, to support determination that the set of multiple bits are to be used for determination of the MCS, the FDRA component 1050 is capable of, configured to, or operable to support a means for determining that the value of the FDRA field satisfies a first MCS field interpretation condition of a set of multiple MCS field interpretation conditions, where each MCS field interpretation condition is associated with a different quantity of the set of multiple bits that are to be used for determination of the MCS.

In some examples, the control signaling component 1025 is capable of, configured to, or operable to support a means for receiving third control signaling including one or more indications of one or more FDRA value thresholds associated with the set of multiple MCS field interpretation conditions.

In some examples, the set of multiple fields includes a time domain resource allocation field, a frequency domain resource allocation field, a modulation and coding scheme field, an uplink shared channel indicator field, or a combination thereof.

In some examples, the first control signaling is downlink control information.

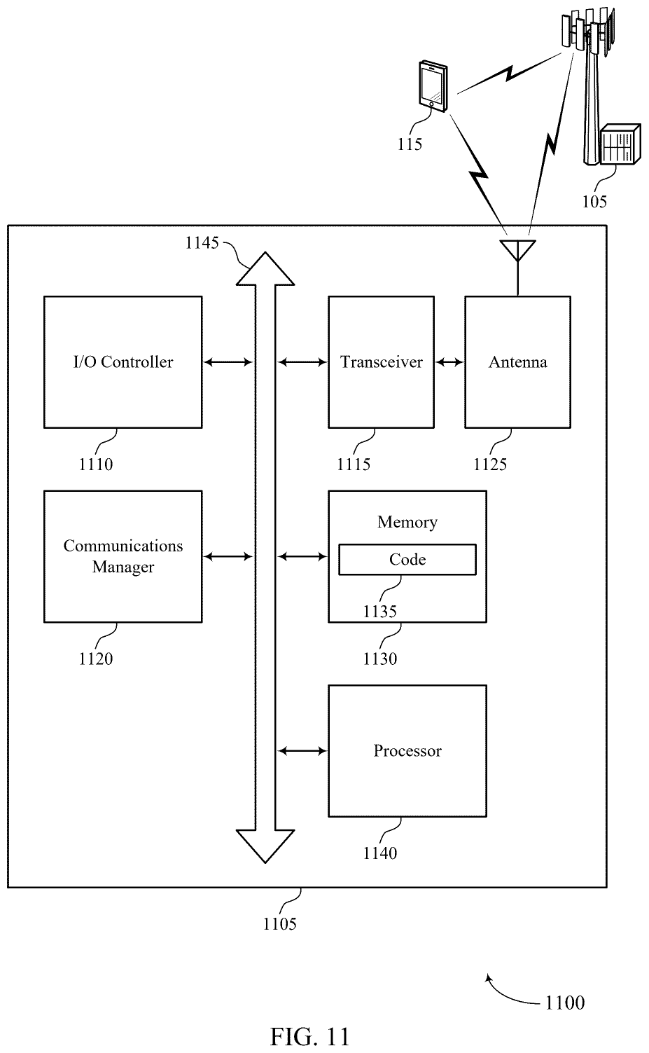

FIG. 11 shows a diagram of a system 1100 including a device 1105 that supports conditional interpretation of control signaling in accordance with one or more examples as disclosed herein. The device 1105 may be an example of or include components of a device 805, a device 905, or a UE 115 as described herein. The device 1105 may communicate (e.g., wirelessly) with one or more other devices (e.g., network nodes 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting conditional interpretation of control signaling). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

Additionally, or alternatively, the communications manager 1120 may support wireless communications in accordance with examples as disclosed herein. For example, the communications manager 1120 is capable of, configured to, or operable to support a means for receiving first control signaling including a set of multiple fields associated with uplink communications of the UE. The communications manager 1120 is capable of, configured to, or operable to support a means for determining an enablement status of orthogonal cover code (OCC) operations for the uplink communications based on whether values of the set of multiple fields satisfy an OCC enablement condition that includes satisfaction of at least two thresholds associated with at least two respective fields of the set of multiple fields. The communications manager 1120 is capable of, configured to, or operable to support a means for communicating a message in accordance with the enablement status of OCC operations.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of conditional interpretation of control signaling as described herein, or the at least one processor 1140 and the at least one memory 1130 may be otherwise configured to, individually or collectively, perform or support such operations.

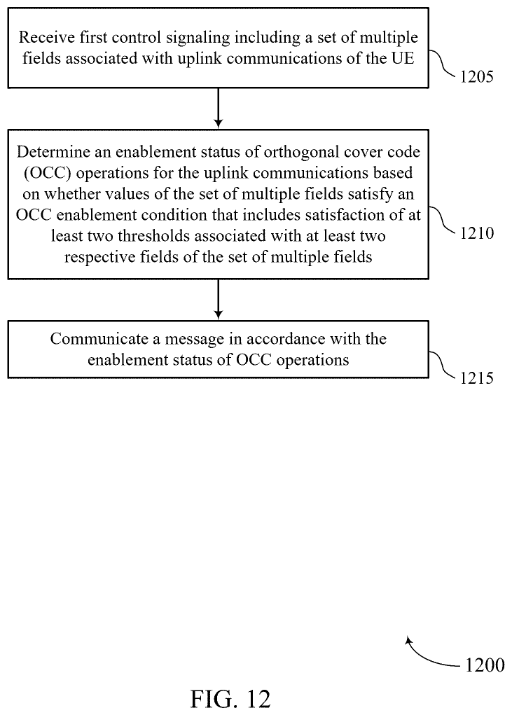

FIG. 12 shows a flowchart illustrating a method 1200 that supports conditional interpretation of control signaling in accordance with one or more examples as disclosed herein. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving first control signaling including a set of multiple fields associated with uplink communications of the UE. The operations of 1205 may be performed in accordance with examples as disclosed herein. In some examples, aspects of the operations of 1205 may be performed by a control signaling component 1025 as described with reference to FIG. 10.

At 1210, the method may include determining an enablement status of orthogonal cover code (OCC) operations for the uplink communications based on whether values of the set of multiple fields satisfy an OCC enablement condition that includes satisfaction of at least two thresholds associated with at least two respective fields of the set of multiple fields. The operations of 1210 may be performed in accordance with examples as disclosed herein. In some examples, aspects of the operations of 1210 may be performed by a OCC enablement component 1030 as described with reference to FIG. 10.

At 1215, the method may include communicating a message in accordance with the enablement status of OCC operations. The operations of 1215 may be performed in accordance with examples as disclosed herein. In some examples, aspects of the operations of 1215 may be performed by a communication component 1035 as described with reference to FIG. 10.

The following provides an overview of aspects of the present disclosure:

Aspect 1: A method for wireless communications at a UE, comprising: receiving first control signaling comprising a plurality of fields associated with uplink communications of the UE; determining an enablement status of orthogonal cover code (OCC) operations for the uplink communications based at least in part on whether values of the plurality of fields satisfy an OCC enablement condition that comprises satisfaction of at least two thresholds associated with at least two respective fields of the plurality of fields; and communicating a message in accordance with the enablement status of OCC operations.

Aspect 2: The method of aspect 1, further comprising: receiving second control signaling comprising one or more indications of the at least two thresholds, an indication of the OCC enablement condition, or both.

Aspect 3: The method of any of aspects 1 through 2, wherein the OCC enablement condition is a predefined condition, one or more of the at least two thresholds are preset conditions, or both.

Aspect 4: The method of any of aspects 1 through 3, further comprising: receiving second control signaling comprising one or more indications of the at least two respective fields.

Aspect 5: The method of any of aspects 1 through 4, wherein the UE is a narrowband internet of things (NB-IOT) device.

Aspect 6: The method of aspect 5, wherein the at least two respective fields comprise a resource assignment field, a subcarrier indication field, a repetition number field, or a combination thereof.

Aspect 7: The method of any of aspects 1 through 6, further comprising: determining, based at least in part on a value of a frequency domain resource allocation (FDRA) field included in the plurality of fields, that a plurality of bits of a modulation and coding scheme (MCS) field included in the plurality of fields are to be used for determination of an MCS to be used for communications involving the UE; and determining the MCS based at least in part the plurality of bits.

Aspect 8: The method of aspect 7, wherein the determination that the plurality of bits are to be used for determination of the MCS comprises: determining that the value of the FDRA field satisfies a first MCS field interpretation condition of a plurality of MCS field interpretation conditions, wherein each MCS field interpretation condition is associated with a different quantity of the plurality of bits that are to be used for determination of the MCS.

Aspect 9: The method of aspect 8, further comprising: receiving third control signaling comprising one or more indications of one or more FDRA value thresholds associated with the plurality of MCS field interpretation conditions.

Aspect 10: The method of any of aspects 1 through 9, wherein the plurality of fields comprises a time domain resource allocation field, a frequency domain resource allocation field, a modulation and coding scheme field, an uplink shared channel indicator field, or a combination thereof.

Aspect 11: The method of any of aspects 1 through 10, wherein the first control signaling is downlink control information.

Aspect 12: A UE for wireless communications, comprising one or more memories storing processor-executable code, and one or more processors coupled with the one or more memories and individually or collectively operable to execute the code to cause the UE to perform a method of any of aspects 1 through 11.

Aspect 13: A UE for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling comprising a plurality of fields associated with uplink communications of the UE;
determine an enablement status of orthogonal cover code (OCC) operations for the uplink communications based at least in part on whether values of the plurality of fields satisfy an OCC enablement condition that comprises satisfaction of at least two thresholds associated with at least two respective fields of the plurality of fields; and
communicate a message in accordance with the enablement status of OCC operations.

2. The UE of claim 1, wherein the one or more processors are individually or collectively further operable to execute the code to cause the UE to:
receive second control signaling comprising one or more indications of the at least two thresholds, an indication of the OCC enablement condition, or both.

3. The UE of claim 1, wherein the OCC enablement condition is a predefined condition, one or more of the at least two thresholds are preset conditions, or both.

4. The UE of claim 1, wherein the one or more processors are individually or collectively further operable to execute the code to cause the UE to:
receive second control signaling comprising one or more indications of the at least two respective fields.

5. The UE of claim 1, wherein the UE is a narrowband internet of things (NB-IOT) device.

6. The UE of claim 5, wherein the at least two respective fields comprise a resource assignment field, a subcarrier indication field, a repetition number field, or a combination thereof.

7. The UE of claim 1, wherein the one or more processors are individually or collectively further operable to execute the code to cause the UE to:
determine, based at least in part on a value of a frequency domain resource allocation (FDRA) field included in the plurality of fields, that a plurality of bits of a modulation and coding scheme (MCS) field included in the plurality of fields are to be used for determination of an MCS to be used for communications involving the UE; and
determine the MCS based at least in part the plurality of bits.

8. The UE of claim 7, wherein, to determine that the plurality of bits is to be used for determination of the MCS, the one or more processors are individually or collectively operable to execute the code to cause the UE to:
determine that the value of the FDRA field satisfies a first MCS field interpretation condition of a plurality of MCS field interpretation conditions, wherein each MCS field interpretation condition is associated with a different quantity of the plurality of bits that are to be used for determination of the MCS.

9. The UE of claim 8, wherein the one or more processors are individually or collectively further operable to execute the code to cause the UE to:
receive third control signaling comprising one or more indications of one or more FDRA value thresholds associated with the plurality of MCS field interpretation conditions.

10. The UE of claim 1, wherein the plurality of fields comprises a time domain resource allocation field, a frequency domain resource allocation field, a modulation and coding scheme field, an uplink shared channel indicator field, or a combination thereof.

11. The UE of claim 1, wherein:
the first control signaling is downlink control information.

12. A method for wireless communications at a user equipment (UE), comprising:
receiving first control signaling comprising a plurality of fields associated with uplink communications of the UE;
determining an enablement status of orthogonal cover code (OCC) operations for the uplink communications based at least in part on whether values of the plurality of fields satisfy an OCC enablement condition that comprises satisfaction of at least two thresholds associated with at least two respective fields of the plurality of fields; and
communicating a message in accordance with the enablement status of OCC operations.

13. The method of claim 12, further comprising:
receiving second control signaling comprising one or more indications of the at least two thresholds, an indication of the OCC enablement condition, or both.

14. The method of claim 12, wherein the OCC enablement condition is a predefined condition, one or more of the at least two thresholds are preset conditions, or both.

15. The method of claim 12, further comprising:
receiving second control signaling comprising one or more indications of the at least two respective fields.

16. The method of claim 12, wherein the UE is a narrowband internet of things (NB-IOT) device.

17. The method of claim 12, further comprising:
determining, based at least in part on a value of a frequency domain resource allocation (FDRA) field included in the plurality of fields, that a plurality of bits of a modulation and coding scheme (MCS) field included in the plurality of fields are to be used for determination of an MCS to be used for communications involving the UE; and
determining the MCS based at least in part the plurality of bits.

18. The method of claim 17, wherein the determination that the plurality of bits are to be used for determination of the MCS comprises:
determining that the value of the FDRA field satisfies a first MCS field interpretation condition of a plurality of MCS field interpretation conditions, wherein each MCS field interpretation condition is associated with a different quantity of the plurality of bits that are to be used for determination of the MCS.

19. The method of claim 18, further comprising:
receiving third control signaling comprising one or more indications of one or more FDRA value thresholds associated with the plurality of MCS field interpretation conditions.

20. A user equipment (UE) for wireless communications, comprising:
means for receiving first control signaling comprising a plurality of fields associated with uplink communications of the UE;
means for determining an enablement status of orthogonal cover code (OCC) operations for the uplink communications based at least in part on whether values of the plurality of fields satisfy an OCC enablement condition that comprises satisfaction of at least two thresholds associated with at least two respective fields of the plurality of fields; and
means for communicating a message in accordance with the enablement status of OCC operations.
